(19) United States
(12) Patent Application Publication
(10) Pub. No.: US 2026/0000209 A1
(43) Pub. Date: Jan. 1, 2026

(54) Adjustable, collapsible, and stowable folding slide-out platform frame system for a bed, table or solid flat surface

(71) Applicant: Michael Lamont Speights, Silver Spring, MD (US)

(72) Inventor: Michael Lamont Speights, Silver Spring, MD (US)

(21) Appl. No.: 18/445,887

(22) Filed: Mar. 6, 2024

(51) Int. Cl. A47C 17/58; A47C 19/04; B60N 3/00

(52) U.S. Cl. CPC A47C 17/58; A47C 19/04; B60N 3/008

(57) ABSTRACT

The invention is an adjustable, collapsible, and stowable folding slide-out platform frame system for a bed, table, or solid flat surface uniquely suited for vehicles and small dwellings. When it is not in use, it can be stowed away in a small wall-mounted compartment so that the space that would be taken up by the platform frame can be cleared of obstructions and able to be used for other purposes. The platform joists which comprise the main support structures are connected to a metal housing component at one end by a bolt that allows the joists to rotate in and out of the storage cabinet. The joists are comprised of nested components that use a telescoping motion to expand over to and rest upon support structures mounted at the opposite end of the housing component. Once expanded and secured in place, the framing system forms a stable support base.

### BACKGROUND AND SUMMARY OF THE INVENTION

This invention falls under USPTO classification 718 as it is a intended to provide a support base for a bed that will receive the human body in a prone, supine, or sitting position for the purpose of repose.

Over time, the design of recreational vehicles has moved towards including more and more features that mimic traditional homes (i.e., full bathrooms, kitchens, and separate bedrooms). This is often accompanied by expanding the size of RVs. Still, small campervans and travel trailers and other small dwellings have remained a staple on the market. In recent years, there has been a growing number of individuals and companies who have focused on converting small commercial vans and passenger vehicles into campervans that offer many of the traditional features of a home in a much smaller space. Despite the proliferation of custom recreational vehicle configurations, there are still certain design aspects that have become normative. The most popular bed systems for vehicle conversions are installed in a manner that consumes a large portion of the available interior space. This includes both “fixed” (permanently installed) beds and modular, convertible bed systems. There are some examples of space-saving designs such as trundle systems that lift up to stand against an abutting wall and folding or sliding systems that convert a bed into seating when not in use.

This invention is the result of an extensive international product search for a bed frame design that would allow for a stable bed support system in a vehicle that could be conveniently stored in an accessible, small space when not in use. After being unable to find a product that satisfactorily suited this purpose, the inventor decided to build his own solution. This invention is collapsible and stowable, making it an ideal space-saving solution for a vehicle or small dwelling. It is a unique innovation because the platform system takes up very little space when stored, allowing the user to utilize the entire footprint of bed area for alternative purposes when the bed is not in use. The parts of the bed that rest on top of the invention (i.e., wood slats, mattress cushions) can be repurposed elsewhere in the living space or are stored separately from the platform frame system when the bed is not set up. For example, the cushions that make up the mattress could be used as seat cushions during the day. The wood slats could be stored in a closet or overhead storage compartment.

Setup up of the platform is also simple and time-efficient. This bed platform frame system expands the installation options for amateur (DIY) and professional recreational vehicle configurations, as well as small dwelling spaces (i.e., tiny homes, cabins). For example, the prototype of this invention was installed in a commercial van in a manner where the platform frame aligns with swiveling seats in the front cabin in order to maximize the utilization of available space in the vehicle. In several years of market research, the inventor has never seen a bed platform system that allows utilization of the front cabin area in conjunction with the rear compartment of the vehicle in this manner to make a bed system. In fact, in nearly all camper van configurations the front cabin of vehicles is exclusively used for seating and driving due to a lack of innovative and efficient solutions for utilizing this space in other ways. The prototype application which can be viewed in FIG. 16 of the Drawings, illustrates how this invention transcends the constraints of existing systems and provides new possibilities for renovating small dwelling areas into multi-functional living spaces.

### DETAILED DESCRIPTION OF THE INVENTION

This invention is an adjustable, collapsible, and stowable platform frame system uniquely designed to provide a space-saving bedding solution for a vehicle, tiny house, cabin, or dwelling. It is a collapsible and stowable wall-mounted bed platform frame system for passenger vehicles, recreational vehicles, and dwellings. The height, width, and length of the system is adjustable and has customizable mounting hardware in order to mount securely to floors, wall studs, stable adjoining structures, and directly to the ribs and wall frame of vehicles.

When not in use, the bed platform joists can be collapsed and stowed inside of a wall-mounted storage cabinet. The wood cabinet frame has 4 sides and a door that is latched closed when the bedding platform frame system is stowed. There is no back wall to the cabinet frame as it's function is purely to cover the platform frame system and secure it in place when it is stowed. The door latch is located at the top center of the cabinet door and frame. There are 3 hinges on the bottom of the cabinet frame, allowing the door to drop down providing access to the platform joists. The cabinet frame is connected to the abutting wall using screws with the appropriate anchors for the material of the abutting wall.

Inside of the cabinet, there is a metal housing component that is securely mounted to the abutting wall using 3 rivet nuts and bolts that are equally spaced across the length of the metal housing component. The metal housing component if made of metal angles welded together to create a structure with a bottom and top shelf for the platform joists to rest on. The prototype of this invention was mounted to the metal ribs of a commercial van. The same methods can be used for other types of vehicles or to mount the metal housing component to wall studs, concrete, or any other solid wall material that is structurally stable enough to handle the load of the objects and users that will rest on top of the system.

The platform joists form the main supportive structure of the system. Each of the two platform joists is comprised of 3 parts. There is a metal square inner-tube, a metal square outer-tube, and a C-shaped metal support bar nests over each of the two platform joists. Each metal square inner-tube is attached by a hinge bolt to the metal housing component, allowing the inner-tube to rotate into storage cabinet where it is stowed and out of the storage cabinet when the platform frame system is being set up for use. The metal square inner-tube nests inside of the metal square outer-tube. The outer tube can freely slide and telescope from the collapsed storage position to the fully extended position. When fully extended, each of the two outer tubes rests on top of a floor support post and/or a wall-mounted support block.

The floor post is made of a square metal tube that is anchored to the floor. The walls at the base of the tube are cut and bent 90 degrees so that the bottom portion can be screwed to the floor. A section of the top front of the square metal tube is cut out in order to allow the extended outer tube of the platform joists to rest on the post and for a metal locking metal pin to be inserted through aligned holes drilled into the floor post and the platform joists. There is also an option to support the platform joists using a wall-mounted support block that is bolted to the walls of a solid, stable, fixed adjoining structure (i.e., a cabinet mounted to the floor, a large dresser or wardrobe, or studs of a wall).

There is a C-shaped support bar that nests on the outside of the metal outer tubes of the two platform joists. These base support bars are attached to the metal outer-tube by a hinge bolt, allowing them to rotate from their nesting storage position out to their in-use support frame position. Once locking metal pins have been inserted to secure the platform joists to the floor posts or wall-mounted support blocks, the C-shaped support bars are both rotated outward. The base support bar on one side is slightly smaller than the bar on the opposite side in order to allow one bar to nest inside of the other. Once the base support bars are connected, a metal pin is inserted through aligned holes in the two base support bars to secure the bars in place. The connected support bars help to ensure that the platform joists remain fixed in place and provide additional support for the load on the frame system.

When the platform frame system is extended and all parts are secured in place, they create a solid, stable platform frame which can be used to set up a bed, table, or other solid flat surface.

Here is a step-by-step guide of the platform set up process:
1. To set up the platform, the cabinet latch is unlocked and the lid is opened downward from the top.
2. Each of the two platform joists is rotated outward and expanded to rest on top of the floor post or wall-mounted support block installed at the opposite end of the platform. After rotating out, the platform joist that is stored on the top shelf of the metal housing slides down to rest on the bottom shelf so that the joists are level to each other.
3. Each platform joist is secured to the support post and/or block at the opposite end using metal pins.
4. The support bars are then rotated out so that the smaller bar nests inside of the other and they are secured together with a metal pin.
5. Once the frame is extracted and the joists and support bar components are interlocked and secured, the platform is ready to provide support for a solid flat surface that spans across the entire width of both joists and along some or all of the length of the joists.

Before resting a mattress, cushions, or other soft bedding structure on top of the platform frame system, some type of flat solid supporting surface (i.e., a box spring or wood slats) must be placed on top of the platform frame in such a manner that is spans perpendicular across the entire span from one joist to the other and rests on both of the platform joists. While a box spring, wood slats, or similar structure are used as part of the set-up process to create a bed, these base items are not being claimed as part of this invention. If boards or slats are used, they can be temporarily secured to the platform if desired by the user by drilling aligned holes through the support base materials and the platform joists where metal pins can be dropped in place to connect the base material and the joists.

To collapse and stow the platform frame system inside of the storage cabinet, the steps of the set up process are conducted in reverse. When placed into the metal housing, one of the platform joists sits on the bottom shelf of the metal housing and the other is raised to rest on the top shelf of the metal housing.

### BRIEF DESCRIPTION OF THE SEVERAL VIEWS

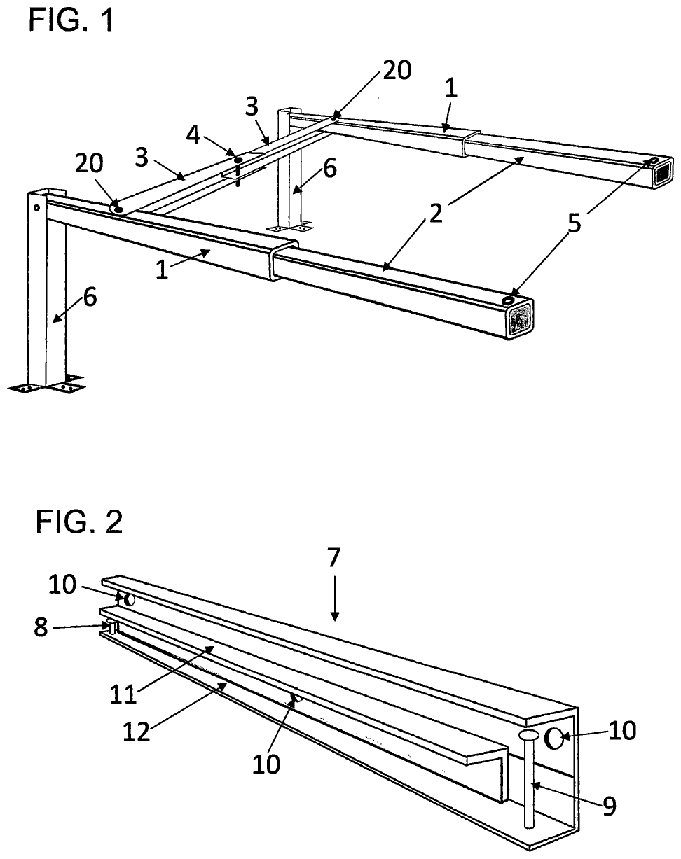

FIG. 1A 3-dimensional view of the extended platform joists and the floor support posts. The metal housing component and storage cabinet are not depicted in this figure. In the full platform frame assembly, the housing component is attached to the end of the platform joists opposite of the floor posts using a bolt to create a hinge that allows the platform joists to rotate into and out of the cabinet.

FIG. 2A 3-dimensional view of the metal housing component that is wall-mounted and provides support on one end of the platform joists and is used to store the platform joists when not in use.

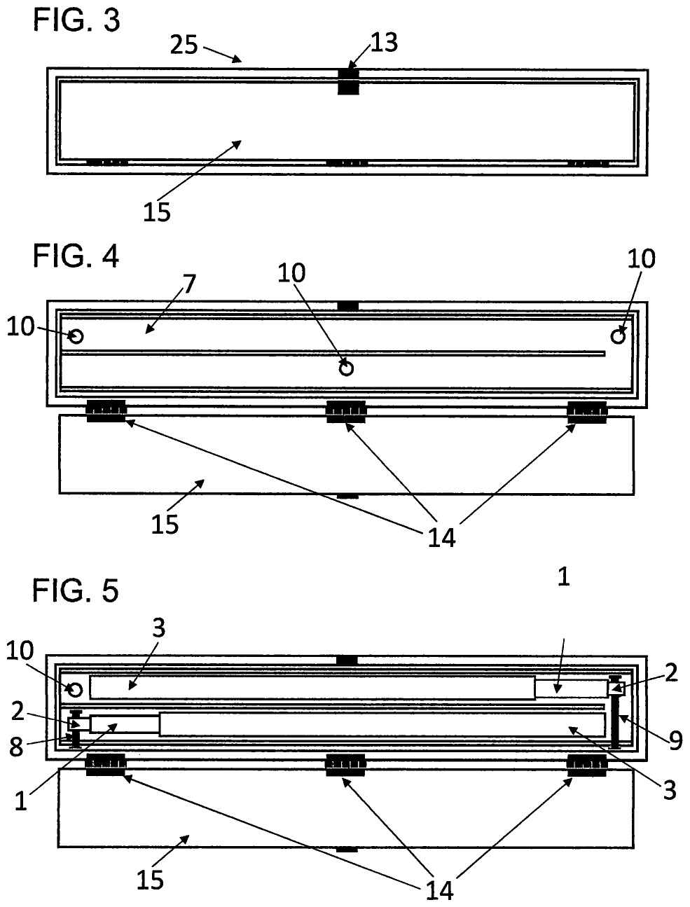

FIG. 3A 2-dimensional front view of the storage cabinet in it's closed and latched position.

FIG. 4A 2-dimensional front view of the storage cabinet with the door unlatched and opened. In this view, the platform joists are not shown inside of the metal housing component.

FIG. 5A 2-dimensional front view of the storage cabinet with the door unlatched and opened. In this view, the platform joists are shown in their stowed positions inside of the metal housing component.

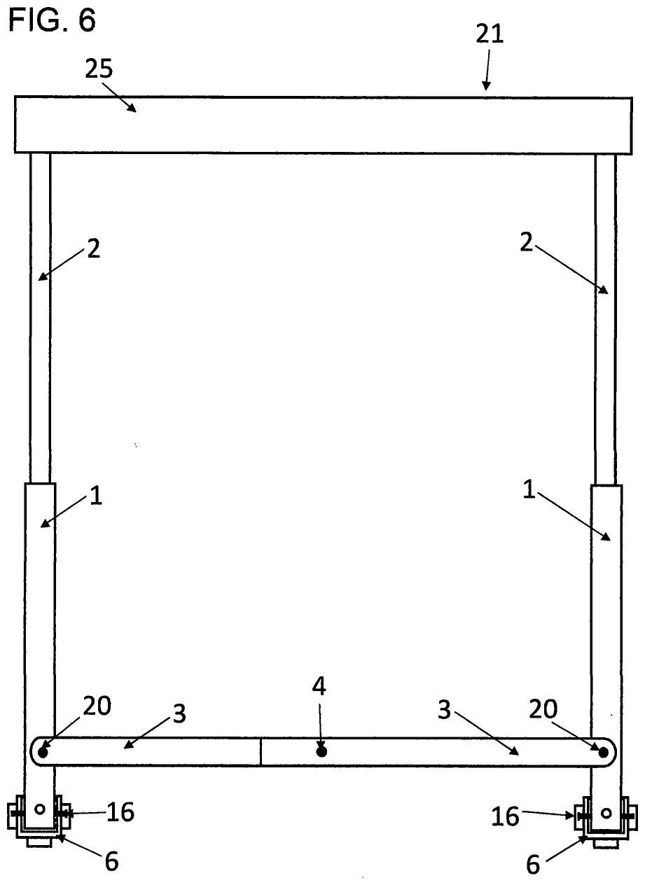

FIG. 6A 2-dimensional top view of the full platform frame system illustrating the platform joists extending from the storage cabinet (with metal housing component inside, but not visible here) to the floor support posts with the C-shaped support bar connected and secured.

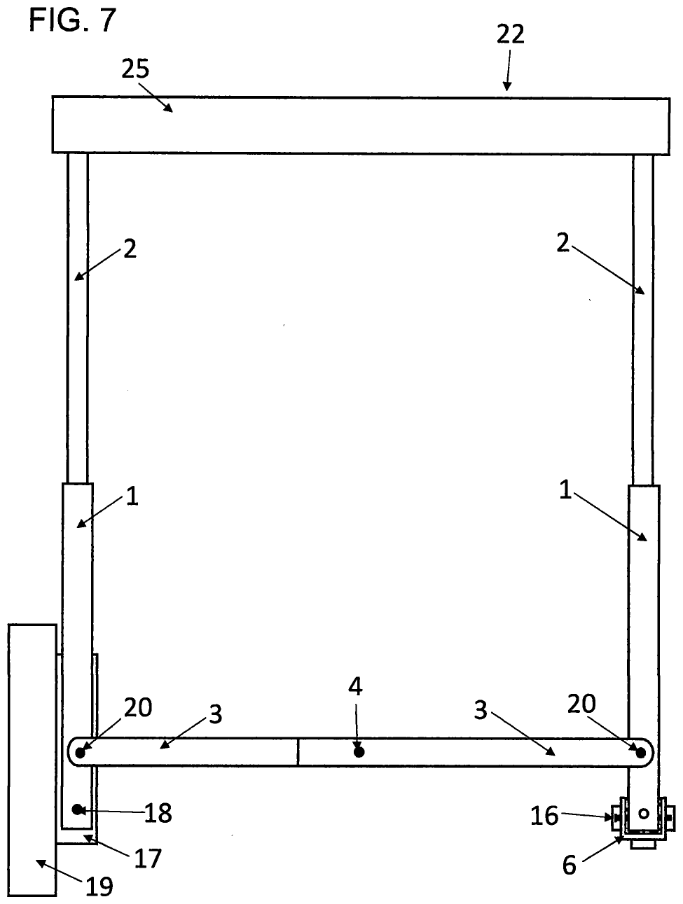

FIG. 7A 2-dimensional top view of the full platform frame system illustrating the platform joist on the right side extending from the storage cabinet (with metal housing component inside, but not visible here) to the floor support posts. The platform joist on the left side is resting on a support block that is anchored to the wall of an adjoining structure. The C-shaped support bars are connected and secured in place by a metal pin.

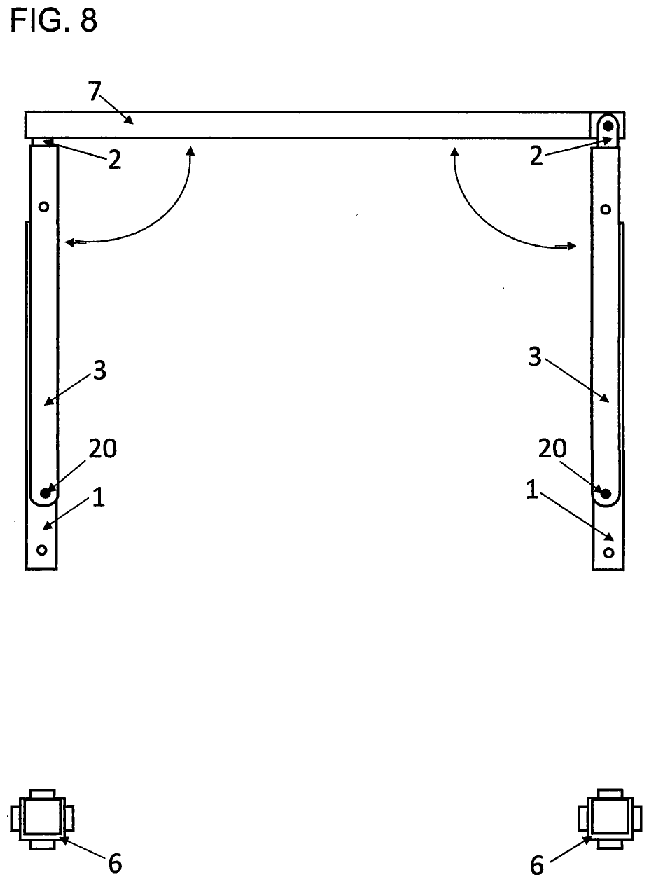

FIG. 8A 2-dimensional top view of the full platform frame system depicting the platform joists after they have been rotated out of the metal housing component, prior to the metal outer-tube of the platform joists being pulled out to rest on the floor posts and prior to the C-shaped support bars being opened and connected. For better clarity, the storage cabinet has been left out of this view.

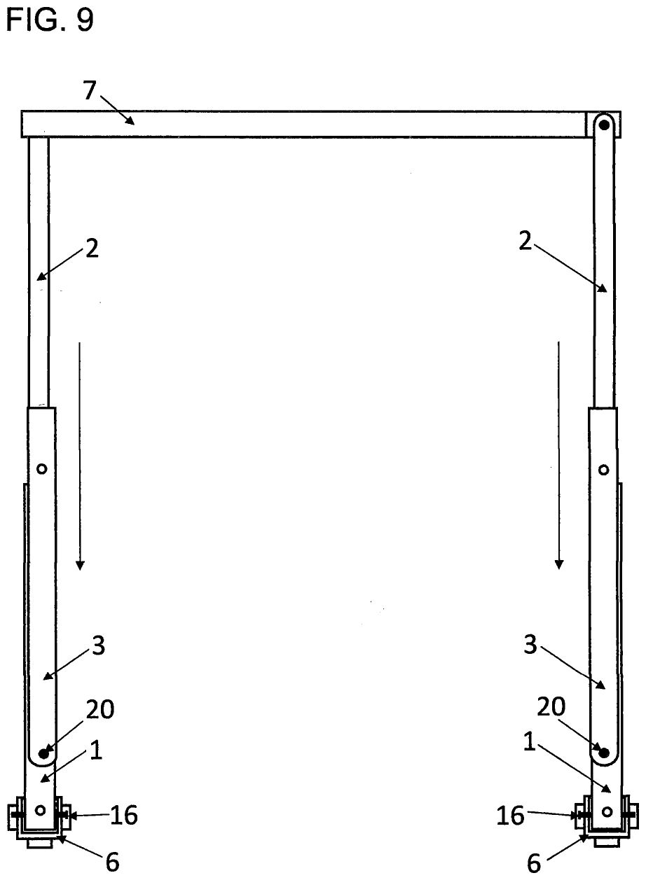

FIG. 9A 2-dimensional top view of the full platform frame system depicting the platform joists after they have been rotated out of the metal housing component and the metal outer-tube of the platform joists have been pulled out to extend and rest secured in place on the floor posts. This is prior to the C-shaped support bars being rotated open and pinned together. For better clarity, the storage cabinet has been left out of this view.

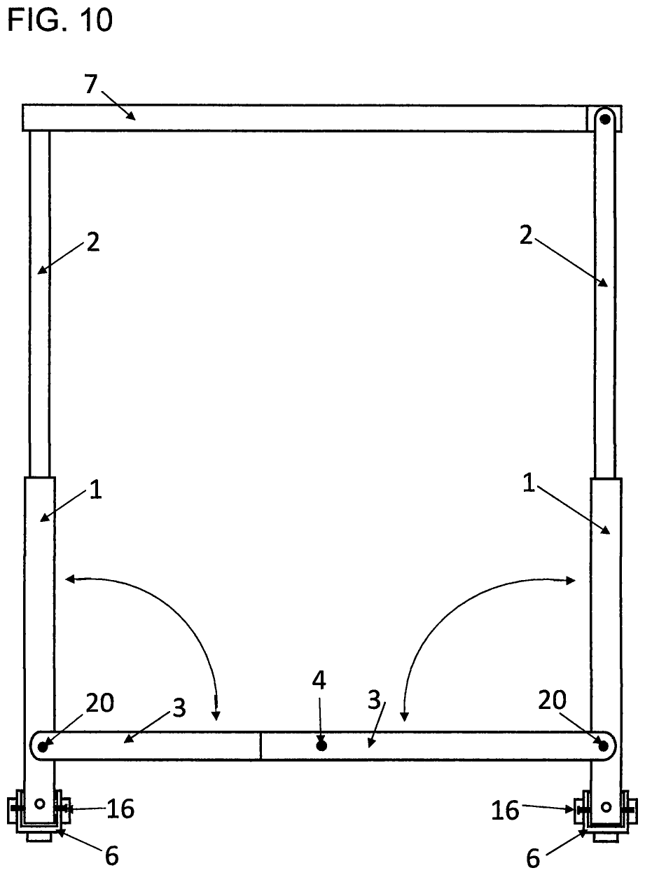

FIG. 10A 2-dimensional top view of the full platform frame system after the setup process is complete. For better clarity, the storage cabinet has been left out of this view.

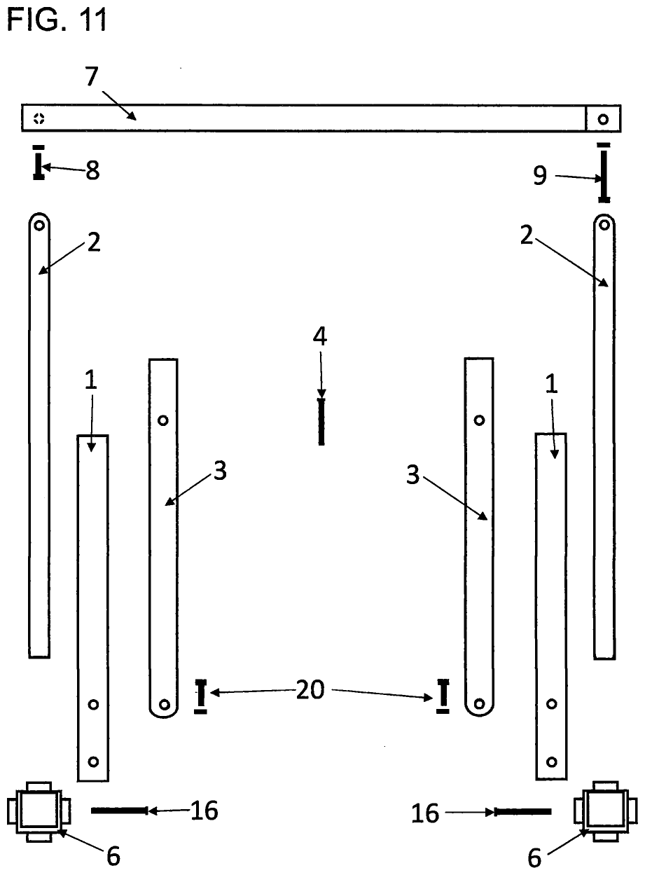

FIG. 11A 2-dimensional top view of all of the parts of the platform joists separated.

FIG. 12A 3-dimensional view illustrating the use of the floor support post to support the platform joist at the end opposite of the metal housing component. The user can install floor posts on both sides, wall-mounted support blocks on both sides, or use a floor post on one side and a wall-mounted support block on the other side.

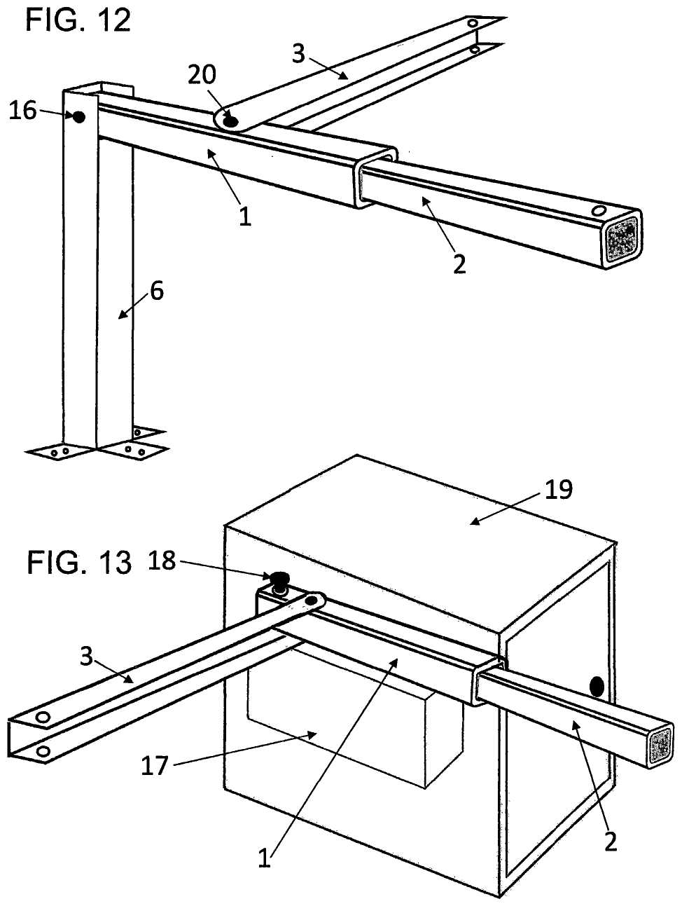

FIG. 13A 3-dimensional view illustrating the use of the wall-mounted support block to support the platform joist at the end opposite of the metal housing component. The wall block must be bolted directly to the framing structure of a solid, stable, fixed adjoining structure (i.e., a cabinet mounted to the floor, wall studs). The user can install floor posts on both sides, wall-mounted support blocks on both sides, or use a floor post on one side and a wall-mounted support block on the other side.

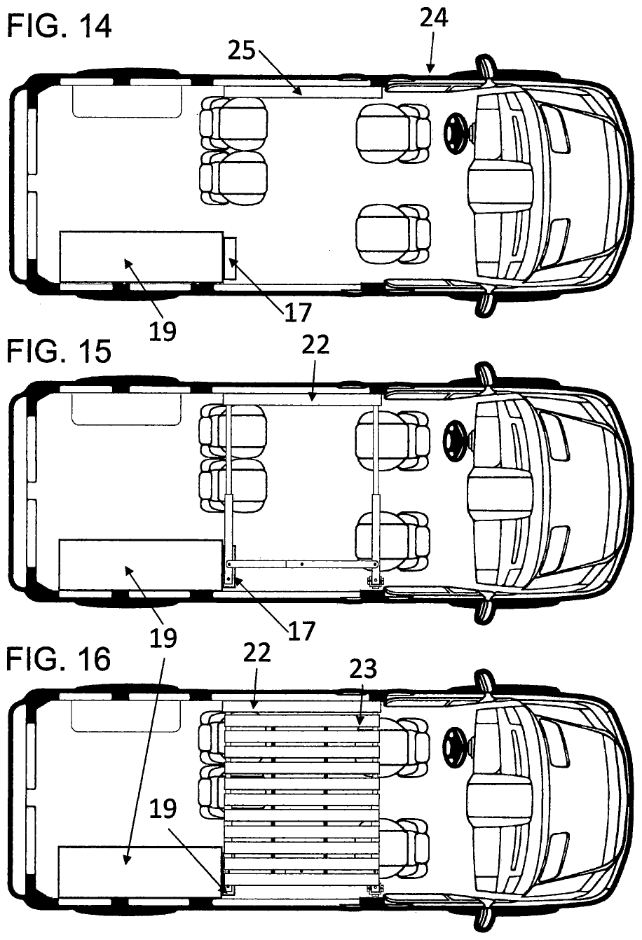

FIG. 14A 2-dimensional top view of an example of the invention in use inside of a van. The platform frame system is depicted in it's stowed position with all parts contained in the storage cabinet.

FIG. 15A 2-dimensional top view of an example of the invention in use in inside of a van in its fully extended position with the left platform joist supported by a wall-mounted support block and the right platform joist supported by a floor support post.

FIG. 16A 2-dimensional top view of an example of the invention in use inside of a van in its fully extended position with a roll of wood bed slats resting on top of the platform framing system. A mattress or cushions can be placed on top of the slats.

### REFERENCE CHARACTERS FOR DRAWINGS

1. Metal square outer tube of the platform joist
2. Metal square inner tube of the platform joist
3. C-Shaped support bar of the platform joist
4. Metal pin inserted into aligned holes at the center of the nested C-shaped support bars
5. Holes through which a bolt connects the platform joists to the metal housing component allowing the joists to rotate on a hinge from stored position to in-use position.
6. Floor support post that is bolted to the floor and helps support the load of the platform frame system and whatever is placed on top of the frame.
7. The metal housing component that is mounted to a wall or vehicle chassis.
8. Hinge Bolt and nut connecting the platform joist to the metal housing component so that it can rotate inward and rest on the bottom shelf.
9. Hinge Bolt and nut connecting the platform joist to the metal housing component so that it can be lifted up and rotated inward to rest on the top shelf.
10. Holes so that the metal housing component can be bolted to the studs of the abutting wall or vehicle chassis.
11. Top shelf of the metal housing component.
12. Bottom shelf of the metal housing component.
13. Door latch on storage cabinet.
14. Hinges at the bottom of the storage cabinet door.
15. Storage cabinet door.
16. Pin that secures platform joist to floor support post.
17. Wall-mounted support block bolted to stable adjoining structure.
18. Pin that secures platform joist to wall-mounted support block.
19. Stable adjoining structure (i.e., a floor-mounted cabinet) capable of supporting the load of the wall-mounted support block.
20. Hinge Bolts connecting C-shaped support bars to metal outer tube of platform joists.
21. Fully extended platform frame system.
22. Example of fully extended platform frame system in use in a vehicle.
23. Roll of wood bed slats used as part of depiction of the invention in use.
24. Van used as a part of depiction of the invention in use.
25. Storage cabinet where platform frame system is stowed when not in use.

1. This invention was created by Michael Speights, the applicant. It is an adjustable, collapsible, and stowable slide-out bed platform frame system comprised of:
a) A wall mounted storage cabinet that contains the platform frame components and hides them from view when the platform frame system is not in use.
b) A metal housing component that is bolted to an abutting wall that serves as a primary support on one end of the platform frame system.
c) Platform joists that are connected to and supported by the metal housing component. Each of the two joists can rotate out of their stowed position in the storage cabinet and can expand using a telescoping, sliding motion to rest on a supportive structure at the opposite end of the metal housing component.
d) Floor-mounted support posts or wall-mounted support blocks carry the load of the platform frame at the opposite side of the metal housing component.
e) Interlocking support bars that are connected to each of the two platform joists on one end by a hinge bolt. The support bars are able to rotate outward from their nested position on the outside of the joists until the smaller of the two bars is nested inside of and aligned with the other bar perpendicular to the platform joists. The two support bars are secured together via a metal pin inserted into aligned holes on each of the support bars.
whereby said platform framing system provides a retractable, collapsible support frame uniquely suited for vehicles and small dwellings by offering a structurally sound platform for a bed, table, or other solid flat surface when it is in use that can be retracted, collapsed, and stowed away in a small wall-mounted compartment when not in use so that the space that is taken up by the platform frame when it is in use is cleared of obstructions and able to be used for other purposes when the platform frame is stowed in its cabinet.
